(19) United States
(12) Patent Application Publication
(10) Pub. No.: US 2024/0028303 A1
(43) Pub. Date: Jan. 25, 2024

(54) METHOD AND SYSTEM FOR ALGORITHM SYNTHESIS USING ALGEBRAIC TOPOLOGICAL TECHNIQUES

(71) Applicants: PRAVEEN VADDADI, HYDERABAD (IN); PRANEETH VADDADI, HYDERABAD (IN)

(72) Inventors: PRAVEEN VADDADI, HYDERABAD (IN); PRANEETH VADDADI, HYDERABAD (IN)

(21) Appl. No.: 17/871,769

(22) Filed: Jul. 22, 2022

(51) Int. Cl. G06F 8/30

(52) U.S. Cl. CPC G06F 8/30

(57) ABSTRACT

In one aspect, a method includes the step of applying specified cybernetics to an algorithm development process. The method includes using one or more algebraic topology principles for the generation or discovery of a new algorithm. The method includes generating a homological description of the new algorithm. The method includes providing the new algorithm as a list making algorithm.

### BACKGROUND

Example embodiments in general relate to software program development tools and more specifically it relates to a method and system for algorithm synthesis using algebraic topological techniques for automatically discovering and/or generating new algorithms.

### SUMMARY OF THE INVENTION

In one aspect, a method includes the step of applying specified cybernetics to an algorithm development process. The method includes using one or more algebraic topology principles for the generation or discovery of a new algorithm. The method includes generating a homological description of the new algorithm. The method includes providing the new algorithm as a list making algorithm.

In another aspect, a computerized method of generating of algorithms from one or more first principles includes the step of utilizing a specified abstract algebra and an algebraic topology for algorithm discovery. The method includes applying a cybernetics principle to an algorithm development process. The method includes using algebraic topology for the generation or discovery of one or more new algorithms. The method includes providing a homological description of the one or more new algorithms.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for implementing an algorithm synthesis using algebraic topological techniques, according to some embodiments.

FIG. 2 illustrates an example process for the initialization routine and/or bootstrap process, according to some embodiments.

FIG. 3 illustrates an example process for implementing a containerized algorithm discovery/synthesis system, according to some embodiments.

FIG. 4 illustrates an example system for implementing an algorithm synthesizer on one or more knowledge component inputs, according to some embodiments.

FIG. 5 illustrates an example process, according to some embodiments.

FIG. 6 describes an example process providing for the generation of algorithms from first principles.

FIG. 7 illustrates an example process for combining algorithms to form computational systems, according to some embodiments.

FIG. 8 illustrates an example process of algorithm synthetization, according to some embodiments.

FIG. 9 depicts an exemplary computing system that can be configured to perform any one of the processes provided herein.

The Figures described above are a representative set and are not exhaustive with respect to embodying the invention.

### DESCRIPTION

Disclosed are a system, method, and article of manufacture for algorithm synthesis using algebraic topological techniques. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Abstract algebra is the study of algebraic structures. Algebraic structures include, inter alia: groups, rings, fields, modules, vector spaces, lattices, algebras, etc.

Algebraic topology is a branch of mathematics that uses tools from abstract algebra to study topological spaces. Algebraic topology seeks to find algebraic invariants that classify topological spaces up to homeomorphism.

Algorithm can be a finite sequence of rigorous instructions, typically used to solve a class of specific problems or to perform a computation.

Container (e.g. OS-level virtualization) can be a virtual runtime environment that runs on top of an operating-system kernel and emulates an operating system (e.g. rather than an underlying hardware).

Cybernetics is concerned with regulatory and purposive systems. Cybernetics is concerned with circular causality or feedback (e.g. where the observed outcomes of actions are taken as inputs for further action in ways that support the pursuit and maintenance of particular conditions, and/or their disruption.

Deep learning is part of a broader family of machine learning methods based on artificial neural networks with representation learning. Learning can be supervised, semi-supervised or unsupervised.

Homology is a procedure to associate a sequence of abelian groups or modules with a given mathematical object. In algebraic topology, homology refers to the procedure of computing a set of algebraic invariants of a given mathematical object. Intuitively, homology counts, for each dimension n, the n-dimensional holes of a mathematical object. For example, a two-dimensional hole is a circle inside a doughnut; a three-dimensional hole is a cavity inside a tooth, etc.

Machine Learning can be the application of AI in a way that allows the system to learn for itself through repeated iterations. It can involve the use of algorithms to parse data and learn from it. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

A Publisher-Subscriber Message Bus enables the creation of a set of components/systems of event producers and consumers (e.g. named publishers and consumers). It allows various services to communicate asynchronously, with low latencies. Publisher-Subscriber Message Busses are generally used as data integration pipelines to ingest and distribute data effectively. One can efficiently distribute many tasks among many worker threads using Publisher-Subscriber Message Busses. They help in parallel processing and workflows and real-time data/event distribution.

Virtualization refers to the provision of runtime environment with certain abstractions for instruction execution components, required to perform a specific function or run an operating system. It abstracts away the physical characteristics of the underlying computing platform and provides a software/hardware interface to underlying microprocessor(s) or multiprocessor(s)

Self-referential systems contain software instructions that can alter their own instructions while they are executing. This characteristic usually helps to simplify maintenance and improve performance by reducing otherwise repetitively similar program instructions.

These definitions are provided by way of example and not of limitation.

### EXAMPLE SYSTEMS AND METHODS

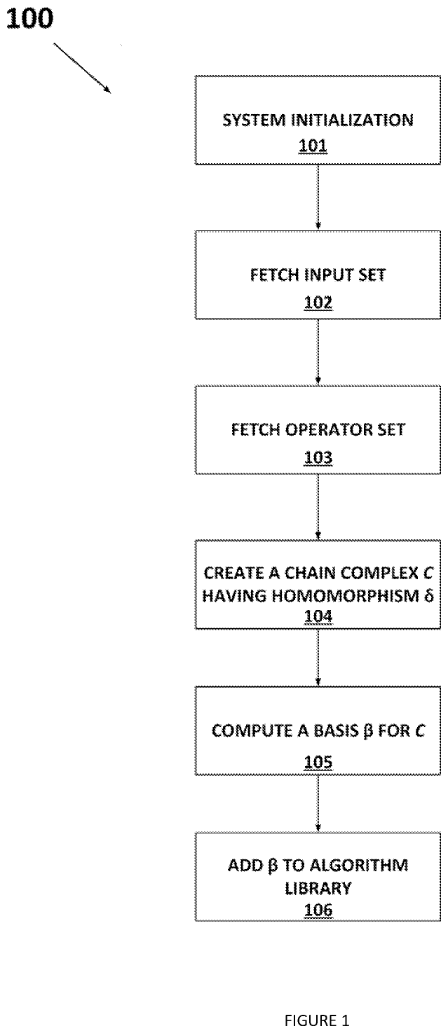

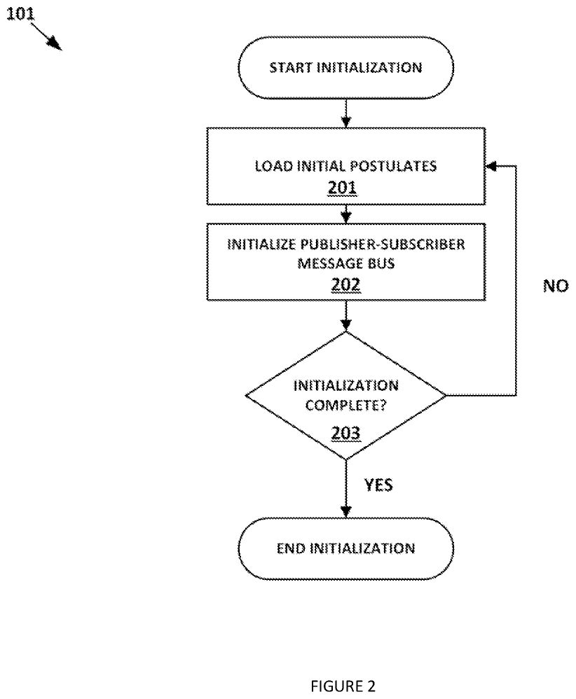

FIG. 1 illustrates an example process 100 for implementing an algorithm synthesis method using algebraic topological techniques, according to some embodiments. Process 100 can be included in an algorithm discovery/synthesis method. In step 101, the system is initialized. In some implementations, this may be a bootstrap procedure or other suitable procedure, as described in further detail with reference to FIG. 2.

In step 102, process 100 can fetch the input set(s). The input set or sets related to the example problem at hand or randomly from a pool of input sources are loaded. In step 103, process 100 can fetch the operator set(s). The operator set or sets (e.g. functions/algorithms/machine-executable instructions that can be applied on input elements) are loaded related to the example problem at hand or randomly from a knowledgebase/library of available operators.

In step 104, process 100 can create a chain C complete having a homomorphism δ. A chain complex is created that satisfies a certain rule described in further detail herein.

At step 105, process 100 computes a basis β for chain C. Basis β for the created chain complex is computed. Basis β can be representative of a generated/discovered algorithm. An alternative method to finding a basis which directly lists a generated algorithm is described in further detail infra.

At step 106, process 100 provides a basis β to the algorithm library. The discovered/generated/synthesized algorithm is added to the algorithm knowledgebase of the system. An alternate example process can containerize the whole algorithm generation operation inside a virtual machine, for example. Process 100 can add a search interface to search and find desired algorithms or specify requirements to generate an algorithm(s) on demand.

FIG. 2 illustrates an example process 200 for the initialization routine and/or bootstrap process, according to some embodiments. In step 201, process 200 loads the initial postulates. A mathematical postulates/theorems knowledgebase is loaded. These mathematical postulates/theorems can be represented/stored in the knowledgebase using a notational programming language like APL (‘A Programming Language’). Such postulates form basic mathematical truths and are expressed as mathematical equations. One such example postulate may be described as a theorem which states that the transpose of a transpose of a matrix is the matrix itself in APL language.

In step 202, process 200 initializes the publisher-subscriber message bus. A producer-consumer message queue can also be initialized. The publisher-consumer bus acts as a communication pipeline for all the system components involved in the operation (e.g. from FIG. 1).

In step 203, process 200 can determine if the initialization is complete. If ‘no’, then process 200 can return to step 201. If ‘yes’ then process 200 can proceed to ending the initialization operations.

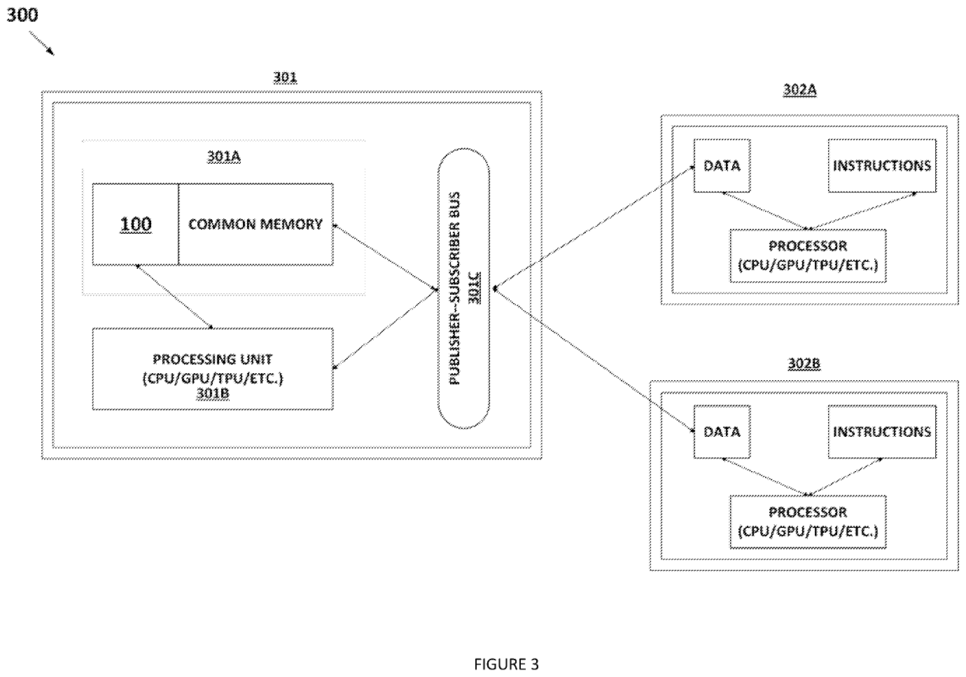

FIG. 3 illustrates an example system 300 for implementing a containerized algorithm discovery/synthesis system, according to some embodiments. In this example embodiment, a containerized system communicates with other computer systems for sharing data and issuing a remote or local procedure/function invocation. System 300 can further associate with multiple distributed memory systems. As shown in FIG. 3, system 300 include virtualized containers 301A-C and 302A-B. System 100 can reside in the computer system and may fetch input and operator sets from its local memory and/or the publisher-subscriber bus 301 C. The connected data and processing systems 302A-B can act as servers for operator and input libraries. After fetching input and operator sets, system 100 generates/synthesizes/discovers an algorithm and publishes it on the publisher-subscriber bus. The generated/discovered/synthesized algorithm is added to the pool/library of the algorithms.

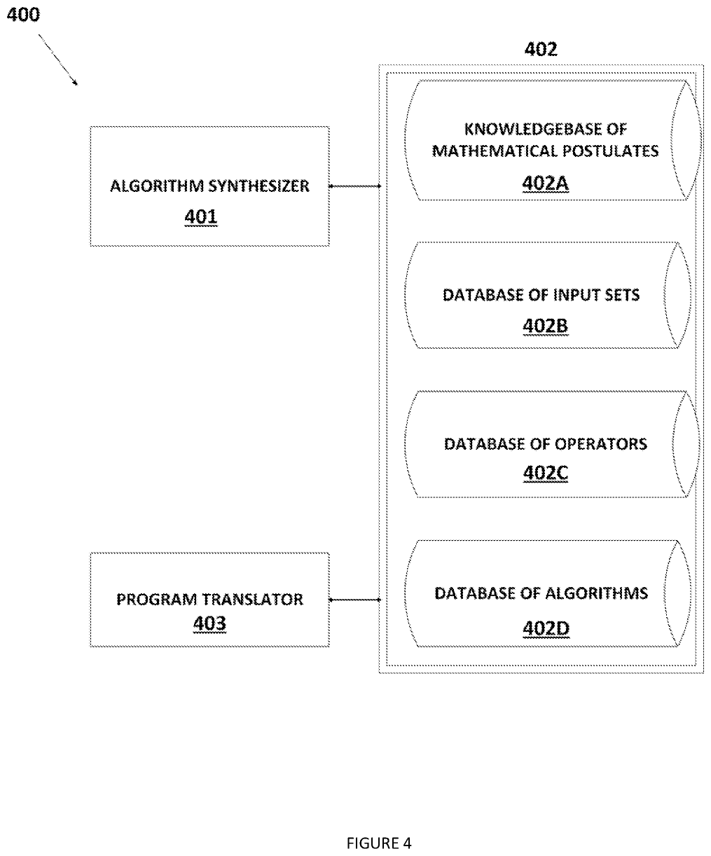

FIG. 4 illustrates an example system 400 for implementing an algorithm synthesizer on one or more knowledge component inputs, according to some embodiments. Of the invention. Algorithm synthesizer 401 can implement process 100. Algorithm synthesizer 401 can obtain inputs. Inputs can include, as shown, inter alia: input, operator, mathematical postulations, and algorithm knowledge bases. Inputs can include knowledge components 402. knowledge components 402 can include, inter alia: knowledgebase of mathematical postulates 402A, database of input sets 402B, database of operators 402C, database of algorithms 402D, etc. Program translator 403 performs programming language translation tasks. These programming language translations can be performed on the discovered/generated/synthesized algorithm from one programming language into another. This process may run in the background and/or on demand.

An example algorithm synthesizer 401 is now described in further detail. As noted, algorithm synthesizer 401 can implement process 100. Algorithm synthesizer 401 can generate and/or discover new algorithms. Given an input set and an allowed set of instructions, a chain complex is generated based on a mathematical postulation. A basis for this chain complex is calculated. This basis is split into two sets: input and instructions. Together with these two sets an algorithm is considered defined. This algorithm is added to the database of discovered/generated algorithms. As shown, algorithm synthesizer 401 is communicatively coupled with knowledgebase component 402. One exemplary interconnection and interoperation is illustrated in FIG. 3.

Algorithm synthesizer 401 can fetch inputs and operators after A system 400 initialization step. Algorithm synthesizer 401 can then assign threads to units of work within system 400 to create a chain complex, compute the basis and generate the algorithm. Depending upon need, these threads can be bundled into worker threads to represent an aggregation of enumerated tasks according to priorities as specified by mathematical postulates. These thread collections/bundles can be arbitered to various hardware like symmetric or clustered multiprocessors, streaming processors, etc.

Algorithm synthesizer 401 can be an amalgamation of continuously generated/synthesized/discovered algorithms. After system 400 is initialized with common memory and communication publisher-subscriber bus setup, a set of inputs, operators and mathematical postulates is fetched from their respective knowledge bases. The sets thus fetched are stored in memory as notations. Programming languages like, inter alia: APL, Mathematica, Maple, GAP, etc. can be utilized.

For example, the set of integers can be denoted by Z and real numbers by R. The list of allowed instructions is called operator set. For example, three operators + (add), − (subtract) and * (multiply) may be chosen as an operator set. Next, one or more mathematical postulates are fetched. These postulates dictate the nature of the synthesized/discovered/generated algorithm. One example set of mathematical postulates may be:
Let the chain complex to be created be denoted by C;
Let the function on C (i.e., its homomorphism) be denoted by δ;
An element in C should either belong to an input set, an instruction set, or an element produced by an instruction;
There exists a sequential ordering of instructions where each instruction depends on either input set, previous instructions or elements produced by previous instructions; and
The input is the smallest subset among all possible inputs.

Such mathematical postulates can be codified using notational or symbolic programming languages like APL, GAP, Mathematica, Maple, etc. or logic languages like PROLOG. It is noted that many (finite) chain complexes can be constructed that satisfy these postulates and compute their basis. The basis consists of a union of three sets: J∪K∪L, where:
J=elements from the quotient group (kernel δ)/(image δ). This also referred to as homology group;
K=elements from the quotient group C/kernel δ; and

L=δ(K).

The discovered/generated/synthesized algorithm is represented by sets J and K. J denotes the minimal input size and K is the list of instructions. The algorithm (input and instruction set) is codified in a notational language like APL. It may also be translated into other languages or machine executable instructions using language translator module 403.

Knowledgebase of operators, inputs, algorithms, and mathematical postulates (e.g. as provided in knowledge components 402) are now discussed. The database of operators (e.g. allowed instructions), inputs and mathematical postulates serve various inputs to use and a combination of one or more instructions/operators/functions allowed to be operated upon the input elements. Once a new algorithm is generated/discovered, it is added to the database of algorithms. One exemplary interconnection and interoperation between the knowledge bases and an algorithm synthesizer is illustrated in FIG. 3.

The databases which hold various input sets may like integers, real numbers, text, etc. usually store the notational code for these sets in one preferred embodiment. For example, instead of storing integers from 1 to infinity, a notation (e.g. in APL) such as (i.∞) is stored. Similarly, various operators/functions are stored in their respective databases. A few such operators that operate on numbers and matrices could be ADD, SUBTRACT, TRANSPOSE, GREAT THAN, LESS THAN, EQUALS, SWAP, INVERSE, SORT, etc. Algorithms that are generated/discovered are also deemed as operators. The mathematical postulates hold various truisms (axioms upon which chain complexes can be built) and can be selected in plurality. It may also hold a library of various chain complexes already created along with their corresponding homomorphisms. One example of a chain complex and its homomorphism function will be described here in detail using an example use case.

An example embodiment of program translator 403 is now discussed. Once a generated algorithm is stored in the database, a program translator may be invoked to translate the algorithm into various programming languages and machine executable instructions using various methods (e.g. like neural network conversion methods, rule-specified methods, etc.).

Program translators 402 can translate APL programs into other languages like C, C++, Java, etc. Also, a support routine to the program translator can run the background that continuously searches for optimal sequence of machine instructions (e.g. custom to underlying hardware) and replaces those with generated ones.

### ADDITIONAL EXAMPLE EMBODIMENTS

The system may also manifest as an on-demand algorithm synthesizer/discoverer. To suit this purpose, a set of desired mathematical postulates is loaded and the algorithm synthesizer 401 is triggered to start with the loaded postulations. A search API can be provided to find the desired algorithm/program in case it has already been synthesized. In some examples, highly specialized processing cores may be utilized/designed to execute the instructions of both the system and the algorithms that are discovered by the system.

An example use case of system 400 is now discussed. In one example, the input can be the set of all integers. The only allowed operator can be ADD (+). The mathematical postulations provided supra can be loaded. Process 100 (and/or process 800) can create a chain complex C=0→Cₙ→Cₙ₋₁→ . . . →C₂→C₁→0 with homomorphism δ.

Let C₁=set of all integers={1, 2, 3, . . . }

Let C₂=set of all instructions={ADD}={(a1, a2) ∈C₁×C₁ such that (a1 ADD a2) ∈C₁

And δ((a₁, a₂))=−a₁−a₂+(a₁ ADD a₂)

Similarly, δ((a₁, a₂, . . . , aₙ))=−((a₂, . . . , aₙ))+Σᵢ₌₁ⁿ⁻¹−1ⁱ((a₁, a₂, . . . (aᵢ ADD a₁₊₁), aₙ))+−1ⁿ(a₁, a₂, . . . , aₙ₋₁).

This ensures δδ=0.

Thus, computing the basis element from homology group, we get {(1)} to be the input set J and the instruction set K equals basis elements from C/(image δ)={(1, a₁, a₂, . . . , aₙ)} and (1+a1+a2+ . . . +an)<n. This instruction set, can depend on (a₁, a₂, . . . , aₙ) and produces (1+a₁, a₂, . . . , aₙ) and can be the synthesized/discovered algorithm.

Thus, applying this synthesized/discovered recursively, starting with input set {1} and setting n=5 the following can be obtained:
{1}

Add 1 to start and add all elements {1,1}→{2}
{1,2}→{3}
{1,3}→{4}
{1,4}→{5}
{1,5}→none
{1,1,1}→{2,1}
{1,1,2}→{2,2}
{1,1,3}→{2,3}
{1,1,4}→none
{1,1,5}→none
{1,2,1}→{2,2,1}
{1,2,2}→none
{2,2,1}→none

In this way, an algorithm can be synthesized/discovered that partitions a given integer n. A library of such homomorphisms and chain complexes can be calculated beforehand and added to the knowledgebase.

### Additional Methods

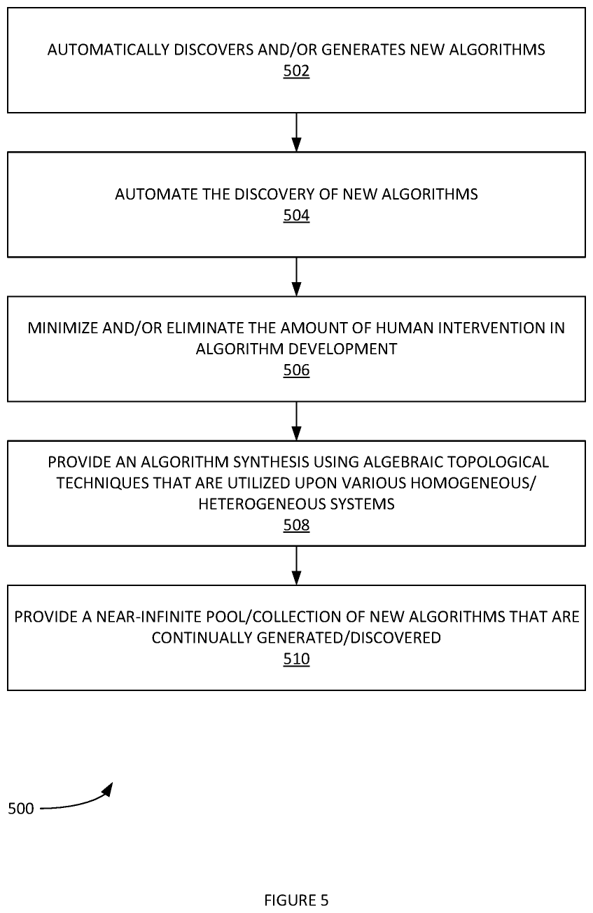

FIG. 5 illustrates an example process 500, according to some embodiments. In step 502, process 500 automatically discovers and/or generates new algorithms. In step 504, automates the discovery of new algorithms. In step 506, process 500 minimizes and/or eliminates the amount of human intervention in algorithm development (e.g. in finding and generating algorithms). In step 508, process 500 provides an algorithm synthesis using algebraic topological techniques that are utilized upon various homogeneous/heterogeneous systems (e.g. databases, operating systems, sensors, autonomous/human-controlled machinery and/or software applications). In step 510, process 500 provides a near-infinite pool/collection of new algorithms that are continually generated/discovered.

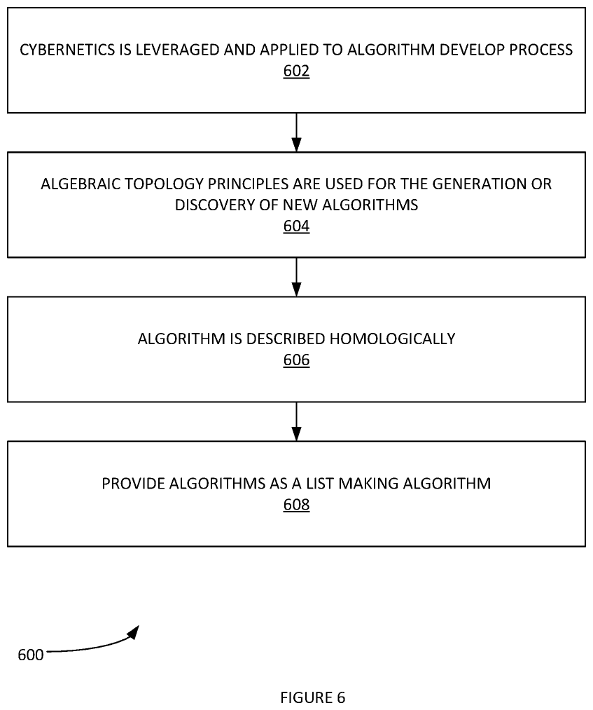

FIG. 6 describes an example process 600 providing for the generation of algorithms from first principles. In process 600, abstract algebra/algebraic topology are utilized for algorithm discovery/synthesis. In step 602, cybernetics is leveraged and applied to the algorithm development process. In step 604, algebraic topology algorithm development process. In step 604, algebraic topology principles are used for the generation or discovery of new algorithms. In step 606, an algorithm is described homologically.

It is noted that algorithms can be regarded as high-dimensional complexes. Process 600 can thus be used to describe exemplary methods (e.g. see supra) to construct such complexes and generate or discover new algorithms. The algorithms discovered/generated are of the list making kind. That is, algorithms that produce list(s) of objects of any type. Since an algorithm is a list of instructions, process 600 can provide algorithms as a list making algorithm in step 608.

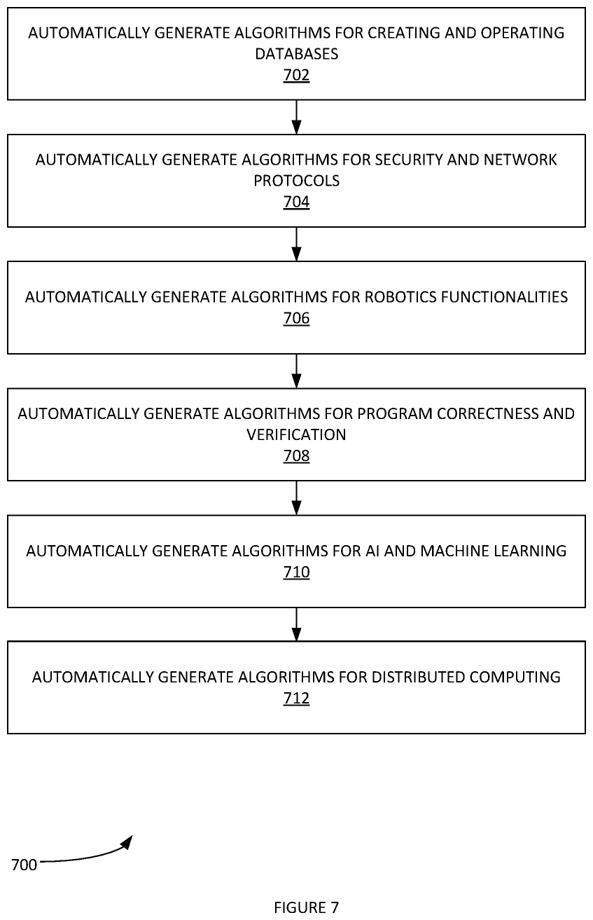

FIG. 7 illustrates an example process 700 for combining algorithms (e.g. like building blocks) to form computational systems, according to some embodiments. In step 702, process 700 can automatically generate algorithms for creating and operating databases. These algorithms can handle massively parallel database updates and fast data retrieval efficiently (and/or finding from the pool of already generated/discovered algorithms). Process 700 can describe homologically a predicate logical sentence satisfying a desired condition.

In step 704, process 700 can automatically generate algorithms for security and network protocols. Process 700 can generate new algorithms on integer factorizations and primality testing. These can help in creating new communication protocols and new ways of securing the channels (e.g. like devising new secure hashing algorithms, etc.) as these problems are a special case of primality testing and the integer factorization problem.

In step 706, process 700 can automatically generate algorithms for robotics functionalities. Issues in robotics like continuous motion planning in a geometric constraint setting can be reduced to discrete abstract algebraic problems (e.g. thus described homologically) and a suitable algorithm may be discovered/generated by the systems and methods provided herein.

In step 708, process 700 can automatically generate algorithms for program correctness and verification. Process 700 can automatically check whether a given program is correct. Since a reverse mapping of a program to an algorithm can be done homologically, and the algorithm has a corresponding topology (e.g. an algebraic topological representation), the correctness can be evaluated based on topology much faster rather than proof checkers.

In step 710, process 700 can automatically generate algorithms for AI and machine learning. For example, new pattern matching algorithms can be discovered by matching the topology of given data to the topology of the generated/available algorithm. Process 700 can have the advantage that it does not suffer from curse of dimensionality and can handle data of many dimensions. Process 700 can also help make the data query free. For example, process 700 can be used to reduce the data to sets and query for a specific question. Instead, process 700 can operate on the topology level of data and plug and play with various algorithms discovered/generated using the proposed system.

In step 712, process 700 can automatically generate algorithms for distributed computing. With process 700, the effective usage of underlying distributed and/or parallel architectures can be made possible by various insights from permutation group theory. Process 700 can use a mathematical scheme that pairs up many subcomponents (e.g. a shuffle network) and propagate the results over a set of permutations. New algorithms can be discovered/generated using process 700 can be used to devise a permutation link exchange network(s) for high performance distributed and parallel computing.

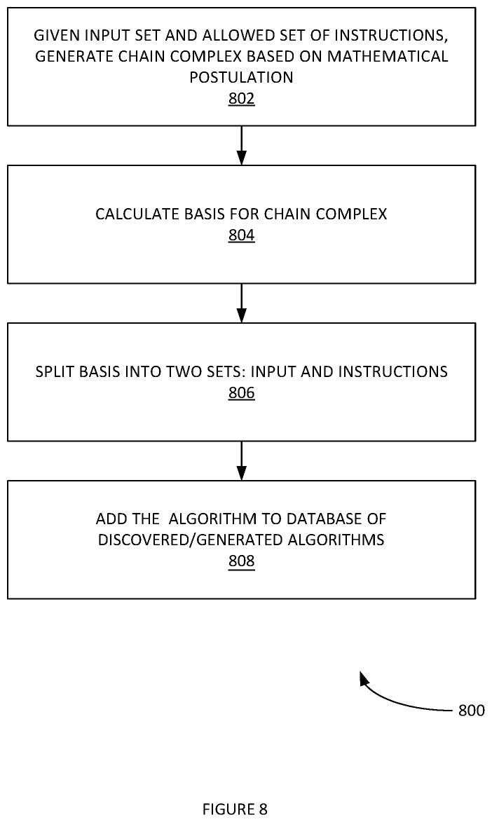

FIG. 8 illustrates an example process 800 of algorithm synthetization, according to some embodiments. In step 802, process 800 can, given an input set and an allowed set of instructions, generate a chain complex based on a mathematical postulation. In step 804, process 800 can calculate a basis for this chain complex. In step 806, process 800 can split the basis into two sets: input and instructions. Together with these two sets an algorithm is considered defined. In step 808, process 800 add the algorithm to a database of discovered/generated algorithms.

Process 800 can utilize the axiom that an algorithm is a certain homomorphism. Algorithms (e.g., a list of instructions) can be multi-dimensional. Process 800 can include a step of embedding an algorithm with a chain complex. For example, a 0-dimensional algorithm can be seen as a chain set of data elements (e.g. input, output, intermediate data results, etc.). A 1-dimensional algorithm chain is a set of algorithms that produce elements of 0-dimensional algorithm chains through the specified homomorphism. A 2-dimensional algorithm chains are meta-algorithms that produce the algorithms that produce 0-dimensional algorithms (e.g., data elements/objects), and so on.

By way of example, to bring a sense of comparison in the programming world, process 800 can represent 0-dimensional instructions as integers or floating points up to a certain finite value. 1-dimensional instructions as the machine language. 2-dimensional instructions as the assembly language. 3-dimensional instructions as higher-level programming language instructions, and so on.

Process 800 can specify a system within a system. This means, for example, that all executable machine instructions (or program instructions) in the processor may be stored within the invention as a knowledge base. In other words, the system may be self-referential, and the algorithm discovered/synthesized may also be self-referential.

In some examples, programming instructions to execute instructions in the processor (e.g. CPU, GPU or TPU) can be stored as a database. In addition to the software instructions, it may also contain necessary subsystems to produce and test various homological descriptors and other algebraic topological objects and the ability to translate these into machine executable language. Process 800 can be used to save memory/data storage space using symbols instead of saving and processing large amounts of input sets. For example, a Unicode symbol infinity can be used to denote a set of integers with cardinality infinity.

### Additional Computing Systems

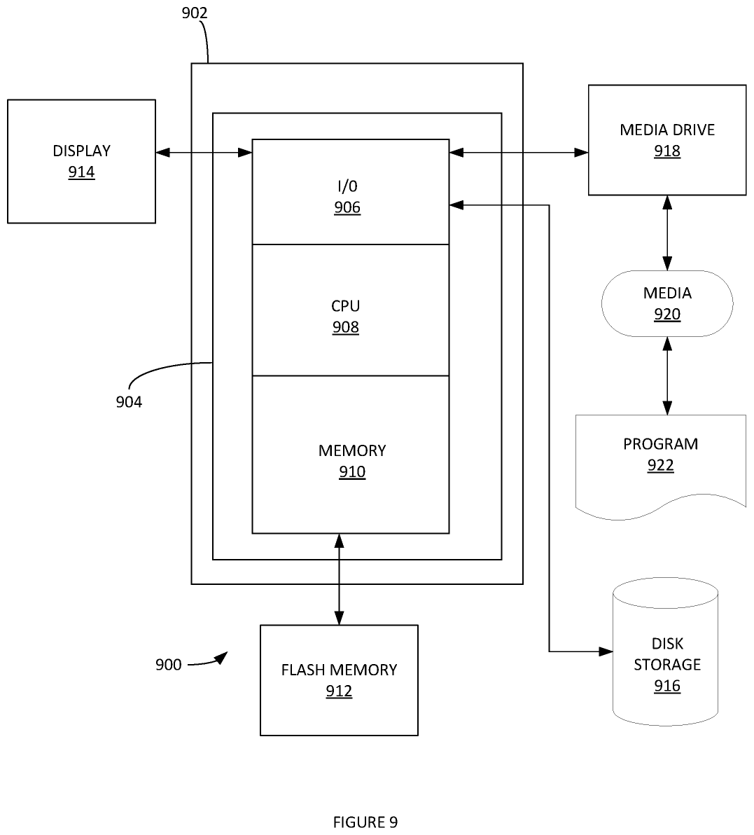

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908 and/or graphical processing unit (GPU), and a memory section 910, which may have a flash memory card 912 related to it. The I/O section 906 can be connected to a display 914, a keyboard and/or another user input (not shown), a disk storage unit 916, and a media drive unit 918. The media drive unit 918 can read/write a computer-readable medium 920, which can contain programs 922 and/or databases. Computing system 900 can include a web browser. Moreover, it is noted that computing system 900 can be configured to include additional systems in order to fulfill various functionalities. Computing system 900 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A method comprising:
applying specified cybernetics to an algorithm development process;
using one or more algebraic topology principles for the generation or discovery of a new algorithm;
generating a homological description of the new algorithm;
providing the new algorithm as a list making algorithm.

2. A computerized method of generating of algorithms from one or more first principles comprising:
utilizing a specified abstract algebra and an algebraic topology for algorithm discovery;
applying a cybernetics principle to an algorithm development process;
using algebraic topology for the generation or discovery of one or more new algorithms; and
providing a homological description of the one or more new algorithms.

3. The computerized method of claim 2, wherein one or more new algorithms comprises a set of high-dimensional complexes.

4. The computerized method of claim 3, wherein the set of high-dimensional complexes are used to describe a method to construct such complexes and generate or discover new algorithms.

5. The computerized method of claim 2, wherein the one or more new algorithms comprise at least one list-making algorithm.

6. The computerized method of claim 2, wherein the one or more new algorithms are used for creating and operating databases.

7. The computerized method of claim 2, wherein the one or more new algorithms are used for security and network protocols.

8. The computerized method of claim 2, wherein the one or more new algorithms are used for robotics functionalities.

9. The computerized method for algorithm synthetization, comprising:
providing an input set;
providing an allowed set of instructions;
based on the input set and the allowed set of instructions, generating a chain complex based on a mathematical postulation;
calculating a basis for the chain complex;
splitting the basis into two sets comprising the input set and the allowed set of instructions;
defining an algorithm with the input set and the allowed set of instructions; and
adding the algorithm to a database of discovered algorithms.

10. The computerized method of claim 9 further comprising:
utilizing an axiom that the algorithm is a specified homomorphism.

11. The computerized method of claim 9 wherein the algorithm is a multi-dimensional algorithm.

12. The computerized method of claim 9 further comprising:
embedding the algorithm within a chain complex.
